(19) United States
(12) Patent Application Publication
(10) Pub. No.: US 2002/0176163 A1
(43) Pub. Date: Nov. 28, 2002

(54) Three dimensionnal display device and image capturing apparatus of the integral photography type

(76) Inventor: Yoshiharu Chikazawa, Yokohama (JP)

Correspondence Address: Joseph S. Tripoli, THOMSON multimedia Licensing Inc., Patent Operations, Two Independence Way, Post Office Box 5312, Princeton, NJ, 08540-5312, US

(21) Appl. No.: 10/115,794

(22) Filed: Apr. 3, 2002

(30) Foreign Application Priority Data
Apr. 20, 2001 (EP) 01401013.6

(51) Int. Cl. G02B 27/22

(52) U.S. Cl. 359/463; 359/462

(57) ABSTRACT

The invention concerns a three dimensional (3D) display apparatus of the integral photography type comprising a passive array (32) of points and an array (30) representing the image to be displayed, this second array comprising a set of subarrays. Each subarray is associated with a corresponding point of the passive array, and each point of each subarray contains an information about a point of the 3D image to be displayed. A light ray from a point of a subarray to the associated point of the passive array virtually converges to the corresponding point of the 3D image to be displayed.

To each point of said passive array (32) are associated optical controllable means (34) receiving the light rays coming from the points of the subarray and passing through said point of the passive array and able to output during n subframes, n being at least equal to 2, light rays in n angular spaces, each angular space providing light rays coming from all the points of the subarray.

### BACKGROUND OF THE INVENTION

The invention relates to a three dimensional (3D) display of the integral photography (IP) type. It relates also to an image capturing apparatus of the IP type.

### DESCRIPTION OF PRIOR ART

For the display of static or dynamic 3D images, only the holographic method and the integral photography method are such that, on one hand, the viewer does not need to wear glasses and, on the other hand, the position of the eyes with respect to the display is not critical in order to obtain a correct 3D image.

Compared to the holographic method, the integral photography has the advantage of a greater simplicity.

This known integral photography method will be explained herein after with reference to FIG. 1 and FIG. 2.

FIG. 1 shows the principle of image capturing. The image capturing equipment comprises an array 10 of holes (or apertures) or lenses a, b, c . . . At a given distance d of this array 10 is provided a set 12 of detectors A, B, C . . . such as CCDs.

Each of those detectors has a predetermined number of detecting elements; this predetermined number is 8 in this simplified example. To each detecting element corresponds a pixel of a flat surface display (for example a liquid crystal display LCD) 14 of the image-reproducing device represented on FIG. 2. When a CCD detecting element receives light, the corresponding display pixel becomes transparent with a transmission coefficient which depends on the light intensity received by the CCD element.

In the example shown on FIG. 1 an object point P illuminates the detector elements A5, B3, C2 and the object point Q illuminates the detector elements A7, B6 and C5.

The correspondence between CCD elements and display pixels is such that to each CCD detector A, B, C . . . corresponds a reproducing section A′, B′, C′ and the order of the pixels in each reproducing section (A′ for example) is inverted with respect to the order of the CCD elements in the corresponding (A) CCD detector. For example on FIG. 1 the CCD element A1 is on the right part of CCD detector A and, on FIG. 2, the corresponding pixel element A′1 is on the left part of this section.

The control of display 14 from signals provided by CCD 12, including the inversion, is realized by a processor not shown on FIGS. 1 and 2.

The reproducing apparatus comprises an array 16 of holes or apertures, or lenses (passive array) corresponding to the array 10 of the image-capturing device. This array 16 is associated to the flat surface display 14 and to a light source 18 in such a way that light emitted by source 18 crosses the display 14 and, afterwards, the holes of array 16. If the array 16 is identical to the array 10 of the capturing device and if the inverted relative positions of pixel elements A′1, A′2, . . . , B′1, B′2, . . . are the same as the relative positions of CCD element, A1, A2, . . . B1, B2, . . . the distance d between array 16 and display 14 is equal to the distance between array 10 and CCD 12.

The light rays A′5-a, B′3-b, and C′2-c converge virtually to point P₁. The light rays A′7a, B′6b and C′5c converge virtually to point Q1. The respective positions of points P₁ and Q₁ are exactly the same as the respective positions of original points P and Q. In other words the integral photography 3D display provides a true 3D image of the original object if there is perfect correspondence between detecting elements and corresponding pixels of flat display, for example LCD 14.

The arrays 10 and 16 may be replaced by arrays of small lenses or equivalent means.

The drawback of the IP method is that the image has a limited resolution. This resolution depends on the number of pixels of each section A′, B′, C′ of the display device and on the number of detectors on each sector for the image capturing device.

### SUMMARY OF THE INVENTION

The invention provides a better resolution for IP capturing device and IP reproducing device without increasing the number of pixels.

In order to achieve this goal the image capturing device comprises, according to the invention, controllable optical means provided, in front of the passive array, for each subarray and the corresponding point of the passive array, these optical controllable means being controlled during n subframes dividing each image frame, the control being such that it divides the detected (or captured) angular space into n subangular spaces, each subangular space at the input of the optical controllable means providing an output covering the whole angular space delimited by all the points of the subarray and the corresponding point of the passive array.

For instance, if n=2 the detected space is divided into two subangular spaces, and during the first subframe all the detector elements of each subarray will be associated to the first subangular space and during the second subframe all the detector elements of each subarray will be associated to the second subangular space. Therefore each point in space will be represented by a number of light rays equal to two times the number of detector elements in a subarray, and the resolution may be multiplied by two.

Moreover the controllable optical element associated to each slit or lens may be also such that the total angular space is greater than the total angular space provided by a single controllable lens or slit.

The controllable element may be a prism with a variable angle.

In that case, the number of subframes may be equal to three and the angle between the faces of the prism take three values, two of them having opposite values and the faces being parallel during the remaining subframe.

The subframes may have equal durations.

The optical controllable means may comprise an optical element which is common to all the subarrays, or an optical element individual to each subarray and to the corresponding point of the passive array.

It must be understood here that each point of the passive array is an aperture or slit of a plate, or a lens.

The invention concerns also a display device or apparatus of the IP type wherein to each point of the passive array are associated optical controllable means receiving the light rays coming from the imaging points of the subarray and passing through said point of the passive array and able to output during n subframes, n being at least equal to 2, light rays in n angular spaces, each angular space providing light rays coming from all the points of the subarray.

The controllable optical means may be one single optical element which is common for all the subarrays, or one controllable optical element may be provided for each subarray.

Preferably, the set of n angular spaces form an angular space which is wider than the angular space defined by the light rays from the point of the passive array and the corresponding set of points of each subarray.

In one embodiment, the subframes have equal durations.

The controllable optical means may comprise a prism and means for varying the angle between the faces of said prism.

In that case the number of subframes may be equal to three and the angle between the faces of the prism take three values, two of them having opposite values and the faces being parallel during the remaining subframe.

The array representing the image to be displayed is for instance a flat surface display, such as a liquid crystal display.

The passive array is an aperture or slit of a plate, or a lens.

### BRIEF DESCRIPTION OF THE DRAWINGS

Other features and advantages of the invention will appear with the following description of certain of its embodiments, wherein:

FIG. 1, already described, represents the principle of an image capturing device of the integral photography type,

FIG. 2, also already described, represents a display device of the integral photography type,

FIG. 3 is a schematic drawing of one part of an embodiment of a display device according to the invention,

FIGS. 4a to 4c are schematic drawings showing the principle of operation in space of the device shown on FIG. 3, and

FIG. 5 is a diagram showing the principle of operation in time of the device represented on FIG. 3.

### DESCRIPTION OF PREFERRED EMBODIMENTS

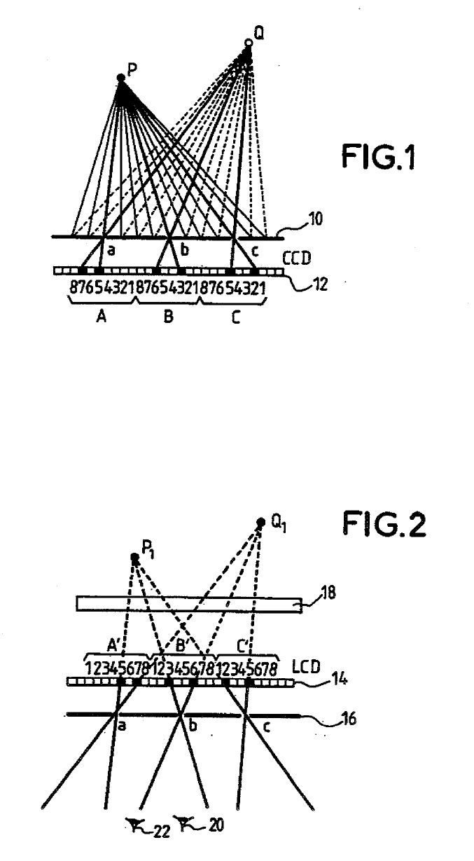

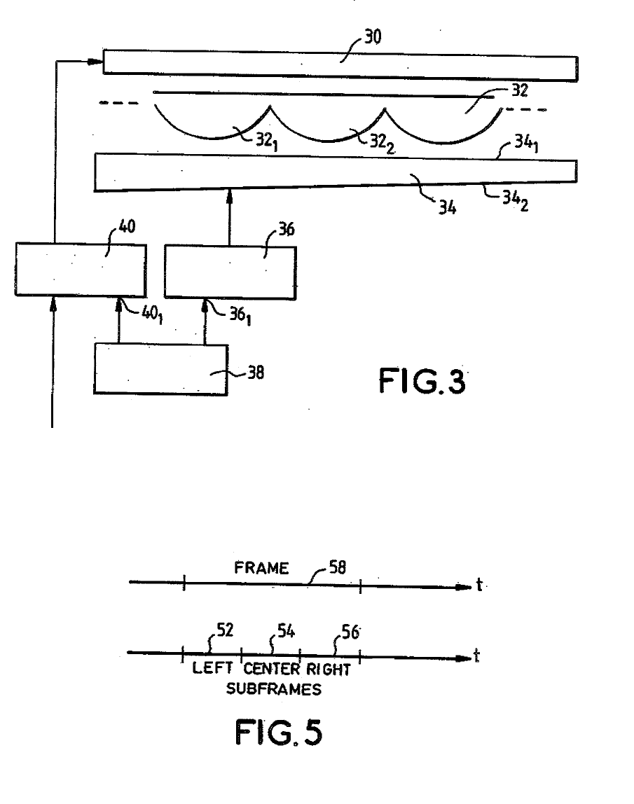

The display device represented on FIG. 3 comprises a LCD display panel 30 which is the same as LCD 14 of FIG. 2. Therefore it is not necessary to describe it again in detail. In front of this display 30 is installed an array 32 of lenses 32₁, 32₂, etc. This passive array 32 has the same function as array 16 on FIG. 2 with slits or holes a, b, c. This array 32 is for instance a flat sheet realized by moulding.

In front of this flat array 32 is installed, opposite to the display 30, a prism 34 having an angle between its two faces 34₁, et 34₂ which is variable under the control of a device 36 synchronized to the image displayed by panel 30. For this purpose a timing signal generator 38 provides a timing signal on an input 36₁ of the control device 36 and on an input 40₁ of a controller 40 driving the pixels on display 30.

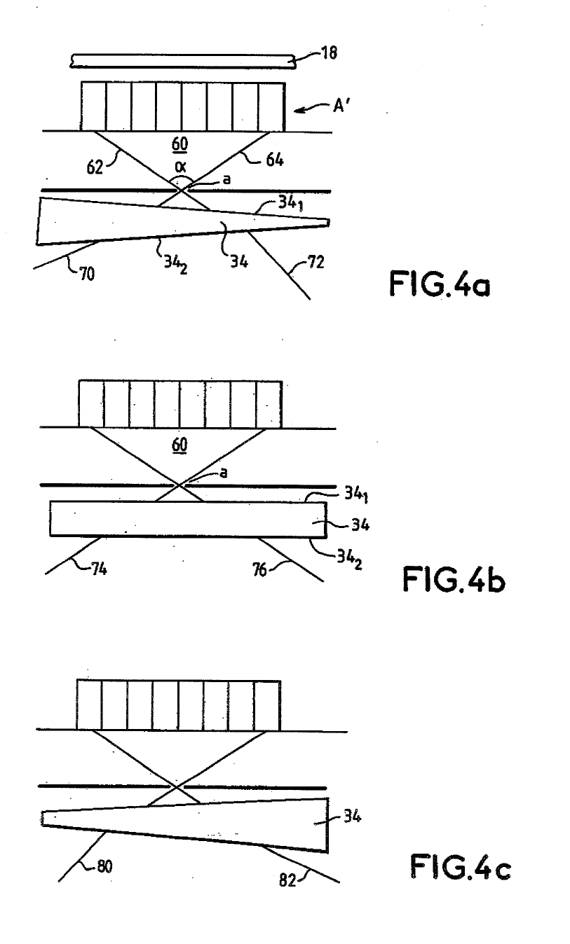

In order to simplify the drawing the operation of the display device is explained with drawings (FIGS. 4a to 4c) similar to the drawing of FIG. 2, i.e. as if the passive array 32 was a slit array.

On these drawings is shown one subset of pixels A′ and the corresponding lens or slit a.

The lens or slit sees the corresponding subset A′ under an angle α, i.e. the light rays of source 18 form an angle α at slit a and the prism 34 is controlled in order to present 3 different angles during 3 different periods, or subframes, 52, 54, 56 (FIG. 5) of one image or frame period 58.

During the first period or subframe 52 the light rays in the angular space 60 delimited, on FIG. 4, by light rays 62 and 64, are deviated by prism 34 in such a way that, at the exit, they are comprised in an angular space which is deviated towards the left and which is delimited by light rays 70 and 72 represented in solid lines.

During the second subframe 54 the faces 34₁ and 34₂ of the controlled prism 34 are parallel (FIG. 4b) and therefore the angular space 60 is transformed in an angular space delimited by light rays 74 and 76.

During the third subframe 56 the prism 34 is controlled in such a way that it provides light rays in an angular space towards the right, i.e. on FIG. 4c, an angular space limited by light rays 80, 82 represented with mixed lines.

As can be seen on FIGS. 4a to 4c, the total angular space delimited by light rays 70 and 82, which is formed of the 3 angular regions corresponding to the 3 different angles of the prism 34 is wider than the input angular space 60.

Therefore, in this example, in addition to increasing the spatial resolution, the display according to the invention provides a greater angle of view.

Although a controllable prism common to all subsets of pixels has been described, other embodiments are possible such as when vari-angle prism for each subset of pixels. Any other means for separating the space in 3 angular regions, or in any number n of regions, is also usable.

In the described embodiment the angular spaces 70, 72; 74, 76; and 80, 82 are overlapping. However, these spaces may be distinct and adjacent, but not overlapping.

In order to control the angle of a prism it is possible, as known per se, for instance to use 2 transparent sheets separated by a transparent liquid and piezoelectrically controlled.

The invention is also usable for image capturing device having a similar structure to the one described with FIGS. 3-5.

What is claimed is:

1. A three dimensional display apparatus of the integral photography type comprising a passive array of points and an array representing the image to be displayed, this second array comprising a set of subarrays, each subarray being associated with a corresponding point of the passive array, and each point of each subarray containing an information about a point of the 3D image to be displayed, a light ray from a point of a subarray to the associated point of the passive array virtually converging to the corresponding point of the 3D image to be displayed, wherein to each point of said passive array are associated optical controllable means receiving the light rays coming from the points of the subarray and passing through said point of the passive array and able to output during n subframes, n being at least equal to 2, light rays in n angular spaces, each angular space providing light rays coming from all the points of the subarray.

2. A 3D display apparatus according to claim 1 wherein the set of n angular spaces form an angular space which is wider than the angular space defined by the light rays from the point of the passive array and the corresponding set of points of each subarray.

3. A 3D display apparatus according to claim 1 wherein the subframes have equal durations.

4. A 3D display apparatus according to claim 1 wherein the optical controllable means comprise an optical element which is common to all the subarrays.

5. A 3D display apparatus according to claim 1 wherein the optical controllable means comprise an optical element individual to each subarray and to the corresponding point of the passive array.

6. A 3D display apparatus according to claim 1 wherein the optical controllable means comprise a prism and means for varying the angle between the faces of said prism.

7. A 3D display apparatus according to claim 6 wherein the number of subframes is equal to three and the angle between the faces of the prism take three values, two of them having opposite values and the faces being parallel during the remaining subframe.

8. A 3D display apparatus according to claim 1 wherein the array representing the image to be displayed is a flat surface display, such as a liquid crystal display.

9. A 3D display apparatus according to claim 1 wherein each point of the passive array is an aperture, or slit, of a plate, or a lens.

10. A three dimensional (3D) image capturing apparatus of the integral photography type comprising a passive array of points or slits or lenses and an array of photodetectors for capturing the image, this second array comprising a set of subarrays, each subarray being associated with a corresponding point of the passive array, and each photodetector of each subarray being able to detect an information about a point of the 3D image to be captured, wherein said apparatus comprises controllable optical means provided in front of the passive array for each subarray and the corresponding point of the passive array, these optical controllable means being controlled during n subframes dividing each image frame, the control being such that it divides the detected angular space into n subangular spaces, each subangular space at the input of the optical controllable means providing an output covering the whole angular space delimited by all the points of the subarray and the corresponding point of the passive array.

11. A 3D image capturing apparatus according to claim 10 wherein the set of n angular spaces form an angular space which is wider than the angular space defined by the light rays from the point of the passive array and the corresponding set of points of each subarray.

12. A 3D image capturing apparatus according to claim 10 wherein the subframes have equal durations.

13. A 3D image capturing apparatus according to claim 10 wherein the optical controllable means comprise an optical element which is common to all the subarrays.

14. A 3D image capturing apparatus according to claim 10 wherein the optical controllable means comprise an optical element individual to each subarray and to the corresponding point of the passive array.

15. A 3D image capturing apparatus according to claim 10 wherein the controllable optical means comprise a prism and means for varying the angle between the faces of said prism.

16. A 3D image capturing apparatus according to claim 15 wherein the number of subframes is equal to three and the angle between the faces of the prism take three values, two of them having opposite values and the faces being parallel during the remaining subframe.

17. A 3D image capturing apparatus according to claim 10 wherein each point of the passive array is an aperture, or slit, of a plate, or a lens.
